(19) United States
(12) Patent Application Publication
(10) Pub. No.: US 2022/0282728 A1
(43) Pub. Date: Sep. 8, 2022

(54) CRANKSHAFT MOUNTED COMPRESSOR

(71) Applicant: Volvo Car Corporation, Goteborg (SE)

(72) Inventors: Peter Kroon, Goteborg (SE); Mattias Svensson, Save (SE)

(21) Appl. No.: 17/679,404

(22) Filed: Feb. 24, 2022

(30) Foreign Application Priority Data
Mar. 4, 2021 (EP) 21160823.7

(51) Int. Cl. F04C 11/00; F04C 2/356; F04C 15/00

(52) U.S. Cl. CPC F04C 11/00; F04C 2/356; F04C 15/0003; F04C 2230/60

(57) ABSTRACT

A system including an engine block and a crankshaft able to rotate around axis A, and a compressor with a rotor, the rotor mounted coaxially to the crankshaft such that the crankshaft drives the rotor. The system can be part of an engine for a vehicle, and the compressor can be an air compressor which is able to supply compressed air for engine systems.

### CROSS-REFERENCE TO RELATED APPLICATION

The present disclosure claims the benefit of priority of co-pending European Patent Application No. 21160823.7, filed on Mar. 4, 2021, and entitled “CRANKSHAFT MOUNTED COMPRESSOR,” the contents of which are incorporated in full by reference herein.

### TECHNICAL FIELD

The present disclosure is related to engines, and in particular engines with a compressor.

### BACKGROUND

Modern engines are a collection of complex and dependent subsystems which must fit in a compact space. Electrical and hybrid engine systems and components often take up more space than those of internal combustion engines alone.

Some engine systems require compressed air, which is typically delivered by an air compressor driven by a belt. This can be the auxiliary or cam belt, which wraps around the crankshaft and then loops over to drive the vane holder of the air compressor.

### SUMMARY

According to a first aspect of the disclosure, a system includes an engine block with a crankshaft able to rotate around axis A, and a compressor with a rotor, the rotor coaxially mounted to the crankshaft such that the crankshaft drives the rotor. Such a system results in a compact package with the crankshaft able to directly drive the compressor rotor, eliminating the need for separate components (e.g., belts) and extra space to accommodate the extra components and drive the compressor. Overall this configuration saves package space, reduces complexity and dependencies while providing a reliable and efficient system for a compressor to be installed on an engine.

According to an embodiment, the crankshaft has a first end, and the rotor is mounted at or near the first end. In other embodiments, the rotor can be mounted a distance from the end. Optionally, the rotor is mounted adjacent to the engine block. By mounting the rotor directly to the crankshaft, the overall engine package with the compressor can be more compact and require fewer parts.

According to an embodiment, the compressor includes a housing, an inlet and an outlet. Optionally, the housing is mounted to the engine block. Further optionally, the housing is mounted to the engine block with bolts. Such a configuration can allow for simple manufacture of the compressor and housing, with simple and secure connections to the engine block such that the rotor can be mounted to the crankshaft.

According to an embodiment, the housing is integral with the engine block. This means that part or all of the housing is formed with the engine block such that it is not able to be removed. This can be, for example, through casting, moulding and/or machining. Such a configuration is simple, having fewer parts, and can save assembly time and costs as the housing does not need to be separately produced and then secured to the engine block. Optionally, the housing includes a lid. This can allow for easy access to the inner parts of a compressor housing even when formed integrally with the engine block.

According to an embodiment, the rotor is mounted to the crankshaft via one or more of the following: shrink fit, splined connection, friction gasket, press-fit, and friction washer. Such connections and/or components help to ensure a secure connection between the crankshaft and compressor rotor such that the rotation of the crankshaft rotates the rotor, thereby driving the compressor. These connections can also help to ensure there is little to no slippage so that the rotor is driven at the desired revolutions per minute (“RPM”) with the crankshaft.

According to an embodiment, the compressor is an air compressor. Such a mechanically driven air compressor is useful for supplying compressed air to auxiliary systems on an engine, and can generally provide more power while taking up less space than prior art alternatives, such as belt-driven mechanical air compressors and electric air compressors.

According to an embodiment, the system further includes one or more seals. Such seals can be shaft seals, lip seals or any types of seals which provide sealing around the compressor and the engine such that fluid from the compressor does not leak into the surroundings and oil from the engine block does not leak out.

According to a further aspect of the disclosure, a method includes obtaining an engine block with a crankshaft; and mounting a rotor of a compressor to the crankshaft coaxially with the crankshaft such that crankshaft rotation directly drives the rotor. Such a method provides a compact and reliable way of delivering compressed air to sub systems of an engine from a compressor while minimizing the number of parts, complexity and space needed for driving the compressor.

According to an embodiment, the method further includes mounting a housing of the compressor to the engine block. This can be with bolts, screws, welding and/or any other means of securely mounting the housing. By mounting the housing to the engine block, the rotor can be mounted securely to the crankshaft such that no additional belt or other component is needed for driving the compressor. Additionally, the air being compressed does not need to travel as far when mounted directly to the engine block. Alternatively, the compressor housing could be formed integral with the engine block, minimizing separate parts even further and reducing assembly time.

According to an embodiment, the method further includes arranging one or more seals between the compressor and the crankshaft. Such seals can be shaft seals, lip seals or other types of seals which can ensure sealing between the compressor, shaft and engine block and thereby reduce the chances of fluid leakage from the compressor and/or the engine.

According to an embodiment, the step of mounting a compressor with a rotor to the crankshaft includes mounting via one or more of the following: shrink fit, splined connection, friction gasket, press-fit, and friction washer. Such mounting options can ensure a secure and reliable connections such that the rotation of the crankshaft rotates the rotor without slippage, thereby driving the rotor and compressor at the desired RPM.

The details of one or more examples are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a perspective view of a compressor connected to an engine block and crankshaft;

FIG. 1B is a cross-sectional view of the compressor;

FIG. 1C is a cross-sectional view through the compressor and a portion of the engine block and crank shaft;

FIG. 2A is a perspective view of a compressor integrated into the engine block; and

FIG. 2B is a view of the compressor of FIG. 2A with a lid removed.

### DETAILED DESCRIPTION

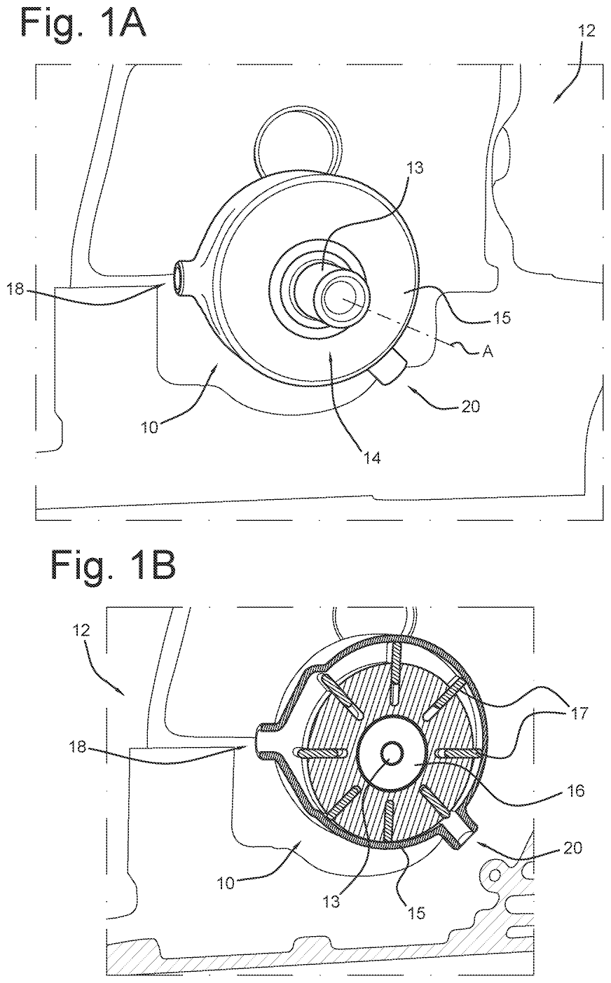

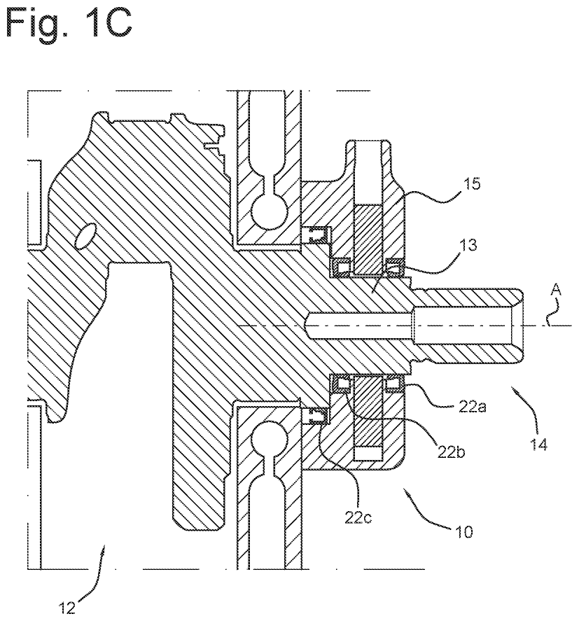

FIG. 1A is a perspective view of a compressor 10 connected to an engine block 12 and crankshaft 13; FIG. 1B is a cross-sectional view of the compressor 10; and FIG. 1C is a cross-sectional view through the compressor 10 and a portion of the engine block 12 and crankshaft 13. Crankshaft 13 includes end 14, which extends out of engine block 12. Engine block 12 is part of an engine, for example, for a vehicle. Crankshaft 13 rotates around axis A.

Compressor 10 can be an air compressor for auxiliary systems, such as a low profile vane compressor or another type of air compressor. Compressor 10 includes housing 15 and rotor 16. Also shown are inlet 18, outlet 20, and seals 22a, 22b, 22c. Inlet 18 and/or outlet 20 can be part of compressor 10 housing 15 or can be separate parts, simply connecting to compressor housing 15. Inlet 18 and/or outlet 20 can be formed as pictured, though in addition or in alternative to what is shown, could have hoses, seals and/or other components necessary to make the sealing connections for air intake and output to various systems.

Seals 22a, 22b, 22c can be shaft seals, lip seals or other types of seals which can ensure sealing between the compressor 10 and crankshaft 13. More or fewer seals could be included, and/or seal placement could be varied depending on the specific engine and compressor configuration.

Housing 15 is connected to an outside of the engine block 12, for example by bolts, screws or other means. Inlet 18 is where air enters compressor 10, flowing into the housing 15, where it is driven by rotor 16 with vanes 17. The air is compressed and exits compressor housing 15 through outlet 20 where it can be taken to other engine systems which require compressed air.

Typically the compressor housing 15 would be plastic or aluminium (including alloys and composites) though could be other types of materials. Rotor 16 and vanes 17 could be formed of a metallic material such as steel or brass, or could be formed of a plastic or other materials which can be directly and securely connected to crankshaft 13.

Rotor 16 of compressor 10 connects directly to and coaxially with crankshaft 13. This connection is shown adjacent to engine block 12, and typically at or near end 14 of crankshaft, though in some embodiments this could be a distance from end 14 and not directly adjacent to engine block 12. This connection is formed such that the rotation of crankshaft 13 rotates rotor 16, driving vanes 17 of compressor 10. The connection can be through a splined connection, shrink fit, friction gasket, press-fit, friction washer and/or any other connection(s) or component(s) which securely connects rotor 16 to crankshaft 13 such that rotor 16 will rotate with the rotation of crankshaft 13 with little to no slippage. This will ensure that the compressor 10 rotor 16 is driven at the desired RPM for properly compressing air in compressor 10 for use in other engine systems.

By securing compressor 10 housing 15 to an outside of the engine block 12 such that compressor 10 is aligned coaxially with crankshaft 13 and rotor 16 is directly connected to crankshaft 16, compressor 10 is able to be directly driven by crankshaft 13. This frees up more space in the overall engine package, allowing for more flexibility in other systems and the vehicle engine as a whole. As mentioned in the background, past systems used compressors which were typically driven by the auxiliary belt or another belt which looped through the engine and connected to the crankshaft. By directly and coaxially connecting the compressor 10 to the crankshaft, more engine space is freed-up.

Such a configuration frees up space which could be used to add other desirable systems to the engine and/or reduce the size of the overall engine thereby improving the efficiency of the vehicle. Such a configuration is especially useful in electrified engines where system components are generally larger and some components which necessitated belts (e.g., alternators) are no longer used.

This configuration can be especially useful in camless piston engines which require compressed air for pneumatic actuation instead of conventional cams. Compressor 10 can provide the required compressed air for such a system, and the compressor 10 could be mounted directly where the cam belt would have been on the crankshaft (since the cam and cam belt are no longer needed in the camless engine). This could also be very useful in electrified engines which do not have an accessory belt and require compressed air and/or when there is no space left on a belt drive. Thus, the compressor 10 is able to be directly integrated into the engine, mounting the rotor 16 to the crankshaft 13 for driving the compressor 10, eliminating the need for a beltdrive or an electric compressor and resulting in an overall savings of space.

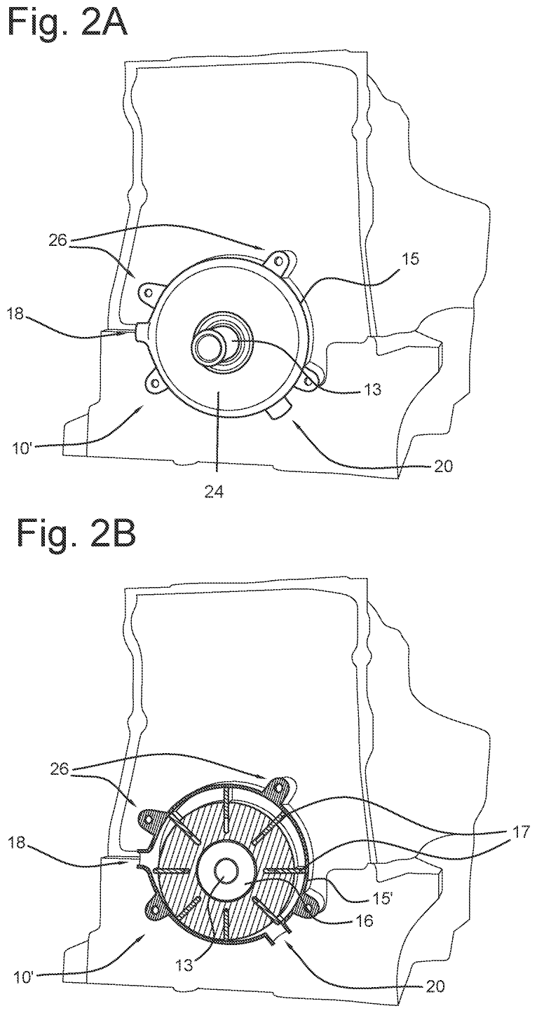

FIG. 2A is a perspective view of a compressor 10′ integrated into the engine block 12, and FIG. 2B is a view of compressor 10′ with the lid 24 removed. Similar numbers are used for similar components, and only the differences will be discussed.

In this embodiment, compressor 10′ housing 15′ is formed integrally into engine block 12 such that the compressor housing is not a separate part. Compressor 10′ includes a lid 24 for access to an inside of compressor 10′. This lid 24 is connected by connection members (e.g., screws, bolts, pins) through connection flanges 26, though could be secured in other manners, for example, snap fit, etc. Inlet 18 and/or outlet 20 can be formed integrally as shown in FIGS. 2A-2B, or can be separate parts, for example, hoses connecting to compressor 10′ to carry air into and out of compressor 10′. Compressor 10′ connects rotor 16 directly to and coaxially to crankshaft 13 such that the rotation of crankshaft 13 rotates rotor 16, as in compressor 10 shown in FIGS. 1A-1C.

Forming compressor 10′ housing integral to engine block 12 can result in even more space savings in the overall engine as well as assembly time savings in not having to separately connect the compressor housing to the engine block. A lid can simply be connected for access to the interior, for example, for easy inspection and maintenance purposes.

In summary, the compressor 10, 10′ rotor 16 is able to be driven directly by the crankshaft 13 without the need for additional belts or other secondary (or more) drive systems and components. Mounting the rotor 16 of compressor 10 coaxially and directly to crankshaft 13 saves package space, reduces complexity and dependencies, and removes the need for a separate electric compressor to run systems requiring compressed air. This makes for an overall reliable, compact and efficient engine configuration, allowing more engine flexibility for including systems which require compressed air while maintaining similar or reduced overall engine package size. Overall, such a configuration saves space in the engine bay, and results in fewer parts, reduced system dependencies, reduced complexity and less maintenance needs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular or preferred embodiments disclosed, but that the disclosure will include all embodiments falling within the scope of the appended claims.

1. A system for a vehicle, the system comprising:
an engine block and a crankshaft able to rotate around axis A, and
a compressor with a rotor mounted coaxially and directly to the crankshaft such that the crankshaft drives the rotor.

2. The system of claim 1, wherein the crankshaft has a first end, and the rotor is mounted at or near the first end.

3. The system of claim 1, wherein the compressor is mounted adjacent to the engine block.

4. The system of claim 1, wherein the compressor comprises a housing, an inlet and an outlet.

5. The system of claim 4, wherein the housing is mounted to the engine block.

6. The system of claim 5, wherein the housing is mounted to the engine block with bolts. The system of claim 4, wherein the housing is integral with the engine block.

8. The system of claim 7, wherein the housing comprises a lid.

9. The system of claim 1, wherein the rotor is mounted to the crankshaft via one or more of the following: a shrink fit, a splined connection, a friction gasket, a press-fit, and a friction washer.

10. The system of claim 1, wherein the compressor is a low profile vane compressor.

11. The system of claim 1, further comprising one or more seals.

12. A method, comprising:
providing an engine block with a crankshaft; and
mounting a compressor with a rotor to the crankshaft directly to and coaxially with the crankshaft such that crankshaft rotation directly drives the rotor.

13. The method of claim 12, further comprising mounting a housing of the compressor to the engine block.

14. The method of claim 12, further comprising arranging one or more seals between the compressor and the crankshaft.

15. The method of claim 12, wherein the step of mounting the compressor with the rotor to the crankshaft comprises mounting via one or more of the following: a shrink fit, a splined connection, a friction gasket, a press-fit, and a friction washer.

16. A vehicle, comprising:
an engine block and a crankshaft able to rotate around axis A, and
a compressor with a rotor mounted coaxially and directly to the crankshaft such that the crankshaft drives the rotor.

17. The vehicle of claim 16, wherein the compressor comprises a housing mounted to or integral with the engine block, an inlet and an outlet.

18. The vehicle of claim 17, wherein the housing comprises a lid.

19. The vehicle of claim 16, wherein the rotor is mounted to the crankshaft via one or more of the following: a shrink fit, a splined connection, a friction gasket, a press-fit, and a friction washer.
